(19) United States
(12) Patent Application Publication
(10) Pub. No.: US 2014/0076925 A1
(43) Pub. Date: Mar. 20, 2014

(54) Beer Bong

(71) Applicants: Tommy S. Sodaro, Discovery Bay, CA (US); Johnny J. Sodaro, Discovery Bay, CA (US)

(72) Inventors: Tommy S. Sodaro, Discovery Bay, CA (US); Johnny J. Sodaro, Discovery Bay, CA (US)

(21) Appl. No.: 13/987,297

(22) Filed: Sep. 17, 2012

(51) Int. Cl. B67D 1/08

(52) U.S. Cl. CPC B67D 1/0889
USPC 222/78

(57) ABSTRACT

A beer bong comprising a mannequin torso, a hose, a funnel, and a valve.

### BRIEF DESCRIPTION OF THE DRAWINGS

FIGS. 1-2 illustrate a beer bong, according to embodiments of the disclosure.

FIG. 3 illustrates a first hole for a beer bong, according to embodiments of the disclosure.

FIG. 4 illustrates a second hole for a beer bong, according to embodiments of the disclosure.

FIG. 5 illustrates a last hole for a beer bong, according to embodiments of the disclosure.

FIG. 6 illustrates a valve for a beer bong, according to embodiments of the disclosure.

FIGS. 7-9 illustrate rubber tubing for a beer bong, according to embodiments of the disclosure.

FIG. 10 illustrates a funnel for a beer bong, according to embodiments of the disclosure.

FIG. 11 illustrates a back perspective view of a beer bong, according to embodiments of the disclosure.

FIG. 12 illustrates a funnel for a beer bong, according to embodiments of the disclosure.

FIG. 13 illustrates a front perspective view of a beer bong, according to embodiments of the disclosure.

FIG. 14 illustrates a back perspective view of a beer bong, according to embodiments of the disclosure.

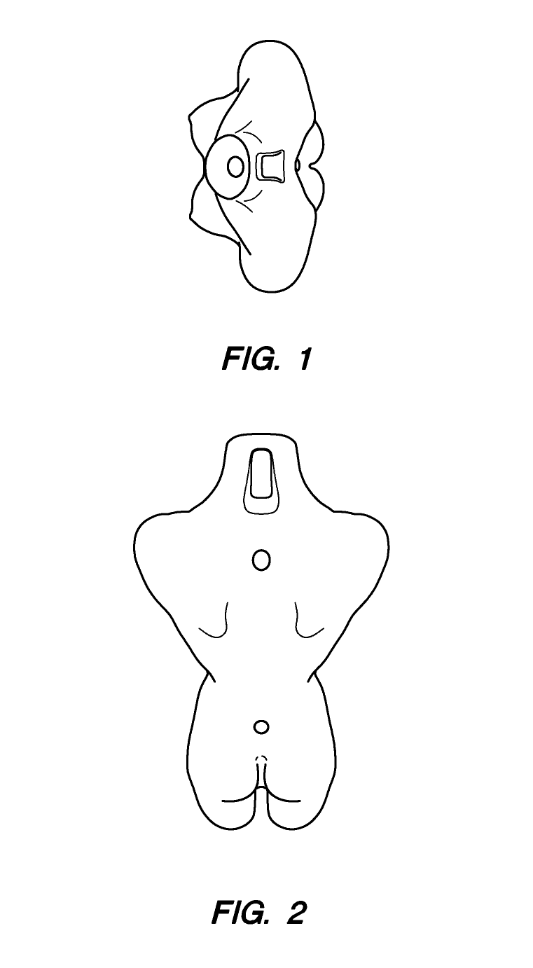

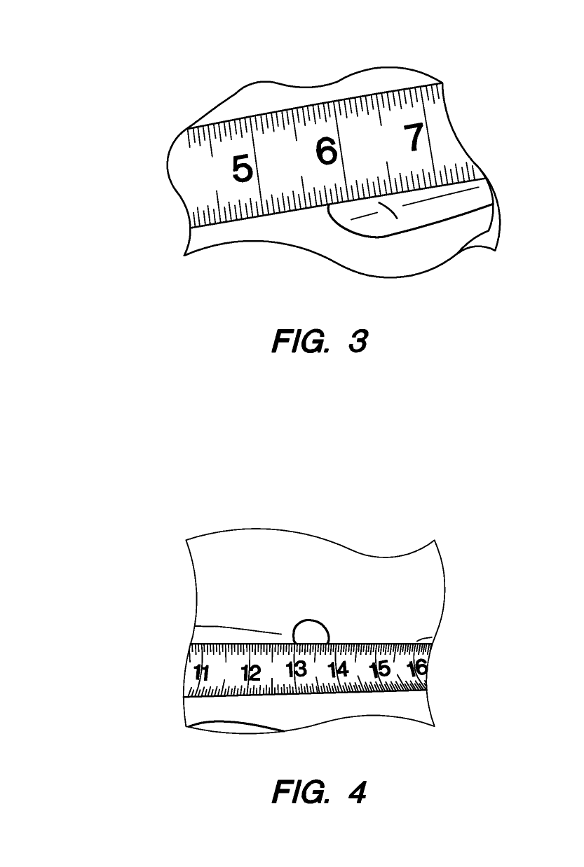

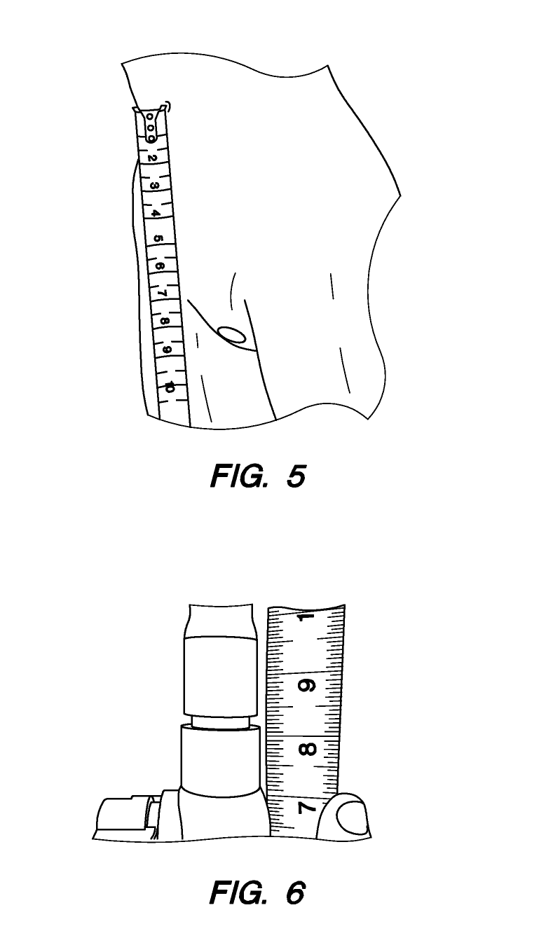

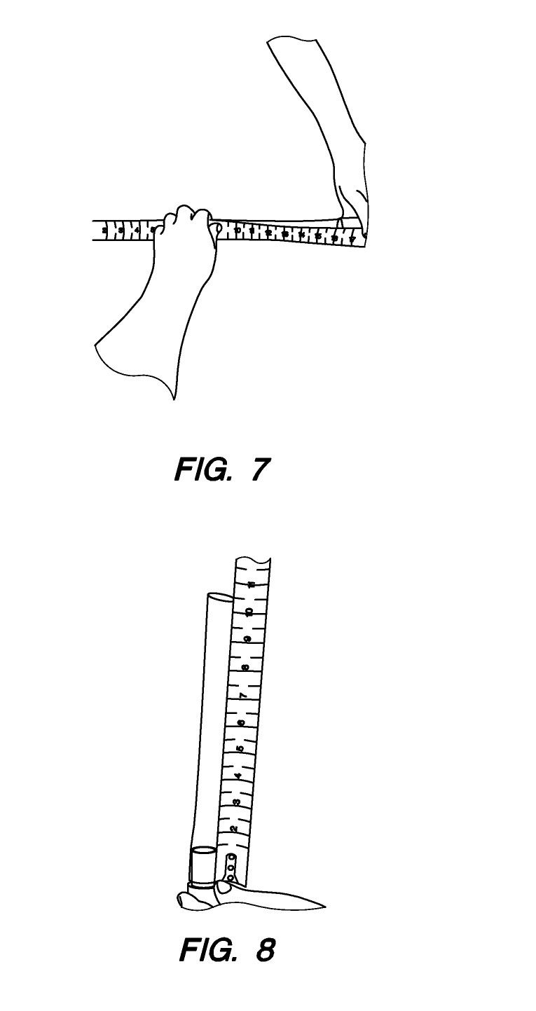

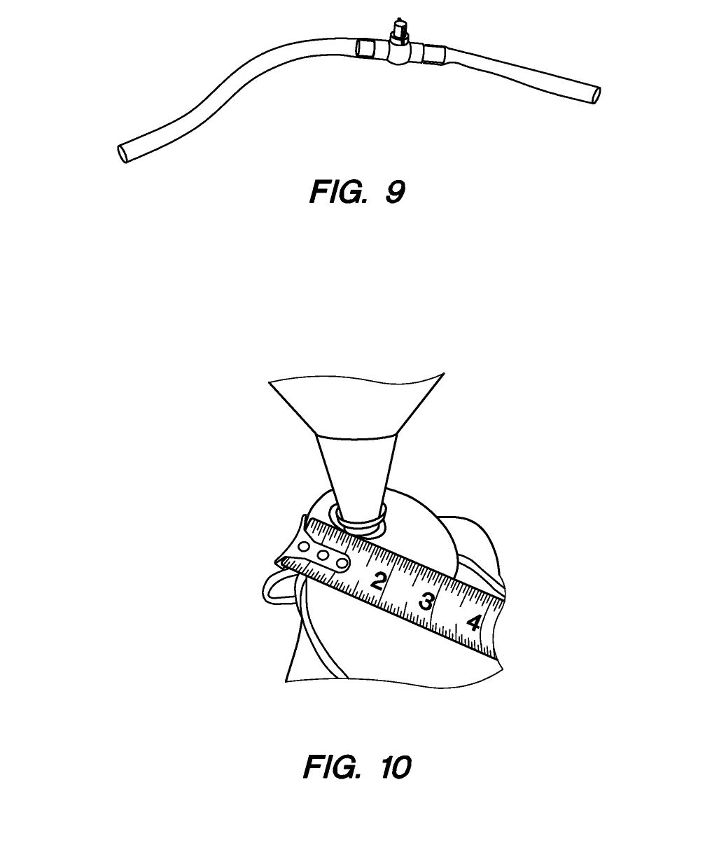

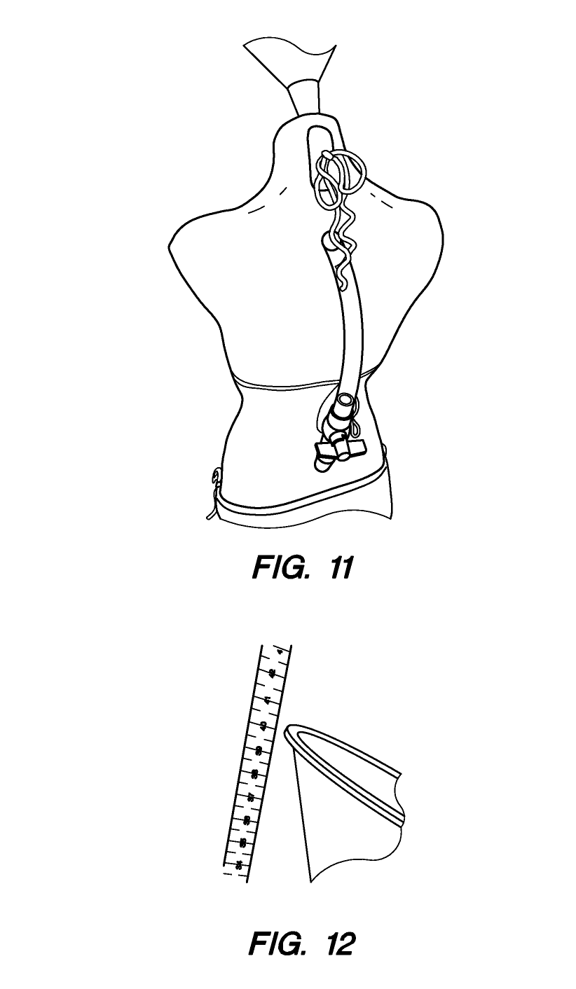

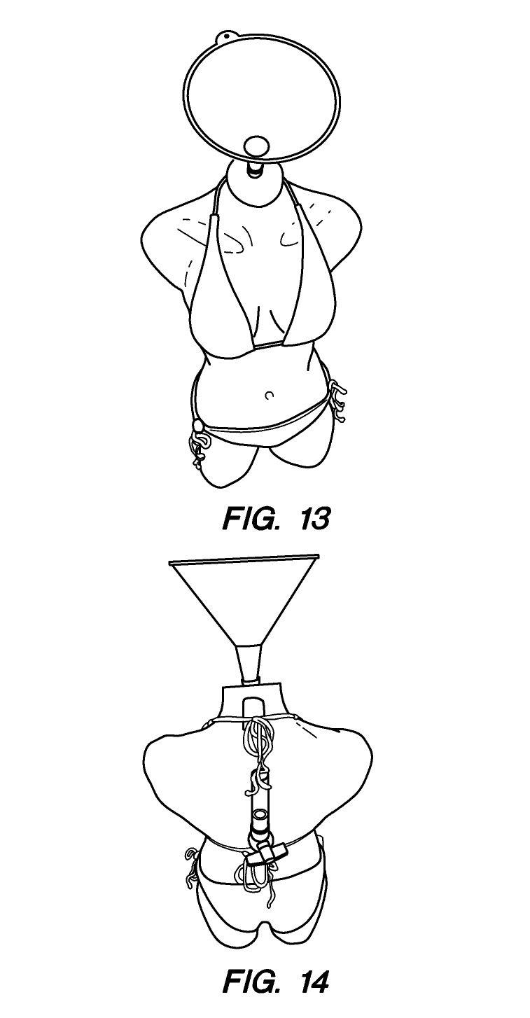

### DETAILED DESCRIPTION

1st we purchased the Female ¾ torso Mannequin from LA Roxy Inc. in East Brunswick, N.J. 08816

2nd purchased the ½′ PVC ball valves from a local supply house along with the 48 oz White plastic funnel's.

3rd was the tubing, we purchased a 100′ box of P.E. 510 Clear Tubing ¾′ id×1″ od

4th we purchased a 10′; stick of ½″ PVC pipe+a pair of PVC cutters & Plastic hose scissors

Tool's needed for installation are:
1—cordless drill
1—1″ hole saw bit with pilot hole center drill bit.
1—PVC pipe cutters
1—Plastic hose cutter

Next is pretty much the instillation & building. Here are the step by steps taken to build.

Using a cordless drill with the 1″ hole saw attachment you drill a hole in the very top where the funnel will eventually be placed.

Next, hole will need to be drilled into the back, in between the shoulder blades then again around the tail bone area.

The first hole in the back needs to be drilled approx. 5¾″ measured from the top of the back of the neck, down.

The second hole to be drilled will need to be 13″ from the top of the back of the neck, down.

The last hole will be on the front of the mannequin in the who ha (i.e., crotch) area. This hole will be about 8¼″ measured from the center of the belly button, down.

Now that all of the drilling is done piping may be cut. Two pieces of PVC pipe are cut at about 3″ in length, using PVC cutters.

Next is the rubber tubing. Two pieces are cut using rubber hose scissors: one piece is about 16½″ and another piece is about 10½″.

Next is a ½″ PVC ball valve having one 3″ PVC pipe inserted in one end and another 3″ PVC pipe inserted in the other end.

Next, the two pieces of rubber tubing are pressed onto the two exposed ends of ½″ PVC pipe. Water may be applied on the PVC pipe to help lubricate the coupling of the hose to the pipe. After both of the hoses are attached, the device should look like the attached figures.

Next is fishing the rubber hose through the back to the exit on the top of the neck and the exit in the front.

Start off with inserting the 16½″ section through the top hole in the back and guide it up fishing it out through the top with your finger. Once it is exposed at least ½″ that's it.

We found a good way to keep the hose in place without it falling back down is to attach the funnel at this time. Holding the hose in place with one hand in the back of the mannequin we just put the tapered end of the funnel in the plastic hose and twist it while pushing down. Once it can't go down any further it will hold itself in place.

Next, is to insert the 10½″ section through the lower hole in the back and guide it out through the exit in the front of the mannequin. Once it is through the front it is complete.

When the assembly is complete the beer bong will be 40½″ tall.

We claim:

1. An apparatus, comprising:
a mannequin torso that includes at least two holes;
a hose that passes through at least a portion of the torso, where a first end of the hose exits the torso at a first hole in the torso and a second end of the hose exits the torso at a second hole in the torso;
a funnel attached to the first end of the hose; and
a valve attached to the second end of the hose.
